(19) United States
(12) Patent Application Publication
(10) Pub. No.: US 2022/0274075 A1
(43) Pub. Date: Sep. 1, 2022

(54) DEVICE FOR MANUFACTURING A PERSONALISED PRODUCT

(71) Applicant: AC&B, Rosieres Pres Troyes (FR)

(72) Inventors: David LELOUP, Troyes (FR); Rémi GYEJACQUOT, Saint Pouange (FR); Christophe BENOIT, MONTEVRAIN (FR); Jean Camille Isidore DEMBEGA, Troyes (FR)

(21) Appl. No.: 17/634,795

(22) PCT Filed: Aug. 12, 2020
(86) PCT No.: PCT/FR2020/000220

§ 371 Date: Feb. 11, 2022

(30) Foreign Application Priority Data
Aug. 12, 2019 (FR) FR1909144

(51) Int. Cl. B01F 33/84; G06Q 30/06; G06K 7/10

(52) U.S. Cl. CPC B01F 33/8442; G06Q 30/0621; B01F 33/846; B01F 33/848; G06K 7/10366; B01F 2101/21

(57) ABSTRACT

The present invention relates to a device (1) for manufacturing a customized product, preferably a customized cosmetic product, by mixing at least two components housed in a respective container, at least one of the containers being a capsule (4), and at least one other container being a pot (2), said containers are each provided with at least one identification code (3), the identification code (3) of the capsule and of the pot being identical or different, and in that said device (1) for manufacturing a customized product comprises at least one means for reading said identification code (3) of the capsule, at least one means for reading said identification code (3) of the pot, said reading means possibly being a single reading means in the case where the identification code (3) of the capsule and of the pot are identical, and at least one means for writing and rewriting identification codes of the capsule and/or of the pot. The present invention also relates to the use of the device according to the invention for preparing a customized product and to a method for checking and monitoring containers and their content for manufacturing a customized product.

The present invention relates to a device (1) for manufacturing a customized product, preferably a customized cosmetic product, by mixing at least two components housed in a respective container, at least one of the containers being a capsule (4), and at least one other container being a pot (2), said containers are each provided with at least one identification code (3), the identification code (3) of the capsule and of the pot being identical or different, and in that said device (1) for manufacturing a customized product comprises at least one means for reading said identification code (3) of the capsule, at least one means for reading said identification code (3) of the pot, said reading means possibly being a single reading means in the case where the identification code (3) of the capsule and of the pot are identical, and at least one means for writing and rewriting identification codes (3) of the capsule and/or of the pot. The present invention also relates to the use of the device according to the invention for preparing a customized product and to a method for checking and monitoring containers and their content for manufacturing a customized product.

The field of the invention particularly relates to the identification and traceability of containers in a device (1) for manufacturing a customized product.

A device is known from FR 1203150 for manufacturing a customized product by mixing at least two components housed in a respective container, using capsules comprising an identification code coupled to means for reading said identification code, said identification code assuming the form of a color code coupled to an optical reading means, in order to identify the component contained in a container.

However, several problems arise. Indeed, by using the solution as disclosed in the prior art, it is impossible to guarantee the source of the containers, and the risk of producing and using counterfeit containers and components is significant, and entails a health risk for the users of said device who do not purchase from an approved retailer. In addition, since the components contained in the containers can be perishable components, it is essential that the opening date of the container is monitored. Finally, when these devices are used in establishments, such as hotels, that can include many of such devices, it is essential that the containers are interchangeable between the machines, and that they can individually identify the content of the containers in terms of the nature, the expiry date and the remaining amount.

Thus, a requirement currently exists for better traceability of the containers used by the devices for manufacturing a customized product, as well as a requirement for enhanced monitoring of the components contained in these containers.

Currently, the Applicant innovates by proposing a device and containers solving the aforementioned problems by virtue of traceability means for the containers and components.

Indeed, the Applicant has developed a device (1) for manufacturing a customized product, comprising means for reading, writing and rewriting identification codes (3), which means are coupled to at least two containers each comprising at least one identification code (3).

Thus, according to a first aspect, the invention relates to a device (1) for manufacturing a customized product, preferably a customized cosmetic product, by mixing at least two components housed in a respective container, at least one of the containers being a capsule (4), and at least one other container being a pot (2), preferably comprising a pump nozzle, characterized in that said device comprises a mixing device, said containers are each provided with at least one identification code (3), the identification code (3) of the capsule and of the pot being identical or different, and in that said device (1) for manufacturing a customized product comprises at least one means for reading said identification code (3) of the capsule, at least one means for reading said identification code (3) of the pot, said reading means possibly being a single reading means in the case where the identification code (3) of the capsule and of the pot are identical, and at least one means for writing and rewriting identification codes (3) of the capsule and/or of the pot.

A container is understood to mean a means for storing a component, preferably a cosmetic component. Examples of containers are pots or capsules in particular.

A pump nozzle is understood, according to the invention, to mean a nozzle that allows, when it is engaged in the orifice of a mixer, delivery of a dose of a component contained in said pot (2).

A capsule is understood, according to the invention, to mean a container allowing pre-dosing of the components, preferably cosmetic components, in particular active components, without manipulation by the user, as well as allowing the components, preferably cosmetic components, to be easily combined, since it simply involves adding as many capsules to their preferably cosmetic customized product as the desired number of components, preferably cosmetic components, in particular active components, to be combined, and allowing optimal preservation of the preferably cosmetic customized product, with the mixture being made extemporaneously, preferably at the time of use.

Indeed, the components, preferably cosmetic components, contained in the capsules (4), in particular the active components, are particularly protected from possible bacterial contamination, oxidation or degradation by UVs.

Identification codes (3) are understood to mean, according to the invention, elements allowing information to be stored that can be read using reading means or with the naked eye. Within the scope of the invention, these codes carry information relating to the containers and the components that they contain, and allow a user or a device to be notified of this information. The codes used within the scope of the present invention can be any identification code (3) within the general knowledge of a person skilled in the art.

Preferably, according to the invention, said identification codes (3) are selected from color codes, RFID chips, barcodes, QR codes, Datamatrix codes, PDF-417 codes, MaxiCodes, NFC tags, mechanical shapes.

Color codes are understood, according to the invention, to mean the use of colors or combinations of colors for characterizing information.

RFID chips are understood, according to the invention, to mean radio-identification “radio-tags,” or “tags” allowing data to be stored and retrieved remotely.

An RFID antenna is understood, according to the invention, to mean an antenna capable of reading the RFID chips. This antenna is also capable of writing and rewriting on the RFID chips.

A barcode is understood, according to the invention, to mean the representation of numeric or alphanumeric data in the form of a symbol made up of bars and spaces, the thickness of which varies as a function of the symbology used and the data thus coded, intended for automated reading by an electronic sensor.

A QR code is understood, according to the invention, to mean a type of two-dimensional barcode made up of black modules arranged in a square with a white background, the arrangement of which defines the information contained in the code.

Datamatrix codes are understood, according to the invention, to mean a type of two-dimensional barcode allowing up to 2,335 alphanumeric characters or 3,116 numeric characters to be shown on a limited surface area, over approximately 1 cm.

PDF-417 codes are understood, according to the invention, to mean the two-dimensional barcode format with a storage capacity of 2,710 characters.

A Maxicode is understood, according to the invention, to mean a two-dimensional barcode that allows 93 alphanumeric characters to be shown on 6.45 cm².

NFC tags are understood, according to the invention, to mean a tag comprising an antenna and a passive chip using Near Field Communication technology.

Mechanical shapes are understood, according to the invention, to mean the shape of the container itself or of one of its elements, forming, for example, a locator, and/or the representation on the container of shapes, for example, points, squares, rectangles, triangles, raised or not raised, organized so as to convey information to the user or to the device according to the invention.

Preferably, according to the invention, the means for reading the identification code (3) of the capsule and/or of the pot, and the means for writing and rewriting the identification code (3) of the capsule and/or of the pot are the same device.

Preferably, according to the invention, at least one of said identification codes (3) of the capsule and/or of the pot is an RFID chip, and the means for reading, writing and rewriting said RFID chip is an RFID antenna (5).

Preferably, according to the invention, the identification code (3) of the capsule is a QR code, the identification code (3) of the pot is an RFID chip, and the means for reading, writing and rewriting said RFID chip is an RFID antenna (5).

A reading means is understood, according to the invention, to mean any means for detecting the presence of an identification code (3) and/or any means capable of reading the information potentially contained in the identification codes (3). An example of a reading means is an RFID antenna or a QR code reader.

The means for reading said identification code(s) (3) are adapted to the selected identification codes (3).

Preferably, according to the invention, said identification codes (3) store information relating to the container and the component, said information comprising the nature of the component and/or the expiry date of the component and/or the source of the container and/or the opening date of the container and/or the remaining amount of the component in the container and/or the number of remaining doses of the component and/or the batch number and/or the serial number and/or parameters allowing the machine to be configured.

The “nature of the component” is understood, according to the invention, to mean the composition of the component in the container.

The “expiry date” is understood, according to the invention, to mean the date on which said component must no longer be used to manufacture a customized product since its freshness is no longer guaranteed.

The “source of the container” is understood, according to the invention, to mean whether the container has indeed been made in an official manner, namely by an approved manufacturer, and not by a possible counterfeiter, for example.

The “opening date of the container” is understood, according to the invention, to mean the date on which the container was opened and/or used for the first time.

The “remaining number of doses” is understood, according to the invention, to mean the remaining number of times the content of the container can be extracted in order to fulfil the production of a customized product according to the invention.

A “batch number” is understood, according to the invention, to mean the batch number of the containers and therefore of the components, preferably cosmetic components, thus allowing all the products of the same batch to be found, for example, in the event of a problem.

A “serial number” is understood, according to the invention, to mean the serial number of the containers and therefore of the components, preferably cosmetic components, thus allowing all the products of the same series to be found, for example, in the event of a health problem.

“Parameters allowing the machine to be configured” is understood, according to the invention, to mean parameters specific to the machine influenced by the information included in the identification codes (3), for example, by the physico-chemical properties of the components, by the fact that the component has perished, or that there is not enough product left to provide a customized product.

Preferably, said identification codes (3) store parameters allowing the machine to be configured.

Preferably, according to the invention, the RFID antenna is configured to rewrite, on the RFID chip, the opening date of the container and/or the remaining amount of the component in the container and/or the number of remaining doses of the component.

“Rewriting on the RFID chip” is understood, according to the invention, to mean that after each use and extraction of the component from the container, the RFID antenna of the device according to the invention sends information to the RFID chip of said container, allowing, during a subsequent use, in the same device according to the invention or in another device according to the invention, said device to identify the opening date of the container and its possible expiry date as a result and/or the level of component in the container and/or the possibility of extracting enough composition in order to prepare the customized, preferably cosmetic, product according to the invention.

Preferably, according to the invention, said device prevents extraction from the container if, when reading the identification codes (3), the nature of the component is not correct and/or the expiry date of the component has passed, and/or the source of the container is not official and/or the remaining amount of the component is insufficient and/or the number doses is equal to 0 and/or the batch and/or serial number is unknown.

Preferably, according to the invention, said device indicates the reason it is preventing the user from extracting from the container, via the interface that can display the information relating to the container and the component that is stored in the identification codes (3).

Said at least two components, preferably cosmetic components, more preferably comprise:
at least one base component; and
at least one, two, three, four, five or at least six active components.

Components are understood, according to the present invention, to mean viscous liquids that can have different viscosity and that can range from 1 centipoise or 0.001 Pa·s (like water, for example) to 500 Pa·s (like butter at 10° C., viscosity measured with a Brookfield DVIII Ultra unit, needle F, Speed 1.5), as well as powders. Preferably, at least one compound in liquid form is selected. It can be, for example, a mixture of liquid paint and powder pigments, a mixture of a hair coloring precursor, for example, an oxidant, a base and a coupler in order to obtain a hair coloring composition, a mixture of two different colored cosmetic shades in order to obtain a foundation of the desired color, a mixture of a cosmetic cream base and one or more active ingredient(s), or even a mixture of a food sauce base and a liquid aroma, or a mixture of a food alcohol, a fruit juice and a food syrup or liqueur for making a cocktail.

Advantageously, according to the invention, the at least two components are at least two cosmetic components, preferably at least one base component and at least one, two, three, four, five, or at least six active components. In a particularly preferable manner, the at least two components are at least one base component and at least one, two, or three active components.

A “base component” is understood to mean a cosmetic component intended to provide the cosmetic product with a particular texture (cream, serum, oil, etc.).

It can be a single ingredient (for example, sweet almond oil) or several ingredients (for example, water, sweet almond oil and an emulsifier) in order to obtain said particular texture.

An “active component” is understood to mean a cosmetic component intended to provide at least one particular activity (anti-ageing, moisturizing, antioxidant, etc.). It can be a single or several active principles combined in order to obtain said particular activity.

Preferably, according to the invention, said device comprises a mixing device.

A “mixing device” is understood to mean a device allowing a combination of several components to be homogenized in order to produce a product, preferably a cosmetic product.

Preferably, according to the invention, said device according to the invention comprises a mixing device as described in documents FR 1203150, FR 1600021, FR 1600023, FR 1600024, WO 2017/118799, WO 2017/118800, WO 2017/118801, WO 2017/118802, WO 2017/118803, which are included herein by way of a reference.

Preferably, according to the invention, said device comprises a device for extracting components from the capsule (4).

An extraction device is understood to mean a device for extracting the content of the capsule (4) in order to supply a mixing device, for example.

Preferably, according to the invention, said device comprises a device for transferring the components to the mixing device.

Even more preferably, according to the invention, said extraction device comprises a device for extracting the components in the capsule (4), and a device for transferring the components to the mixing device, preferably a hollow needle and a suction means, respectively.

Preferably, according to the invention, said device according to the invention comprises an extraction device as described in documents FR 1203150, FR 1600021, FR 1600023, FR 1600024, WO 2017/118799, WO 2017/118800, WO 2017/118801, WO 2017/118802, WO 2017/118803, which are included herein by way of a reference.

Preferably, according to the invention, said device comprises a customized data collection interface capable of interacting with the user to allow the user to indicate their customized data, preferably selected from a predefined database.

A data collection interface is understood, according to the present invention, to mean an interface, preferably a computer interface, that allows a user, or a third party on behalf of the user, to enter their customized data that will be recorded and/or transferred, for example, from a database, to a data processing device.

Preferably, according to the invention, the customized data includes the age of the user, the sex of the user, the number of hours of sport per day or per week of the user, the number of hours of sleep per night of the user, the temperature of the environment in which the user circulates, the humidity level of the environment in which the user circulates, the pollution level of the environment in which the user circulates, and/or the features of the skin of the user.

The features of the skin of the user are understood to particularly denote, according to the present invention, the type of skin of the user (such as dry skin, oily skin, combination skin, or normal skin), the phototype of the skin of the user, the color of the skin, the radiance of the complexion (such as a dull complexion, or a luminous complexion), the sensitivity of the skin of the user, the presence of wrinkles and/or fine lines on the skin of the user, the presence of spots on the skin of the user, the possible lack of firmness of the skin of the user, and/or the presence of dark circles and/or puffiness in the eye contour area.

Preferably, this means the age of the user, the sex of the user, the number of hours of sport per day or per week of the user, the number of hours of sleep per night of the user, the temperature of the environment in which the user circulates, the humidity level of the environment in which the user circulates, the pollution level of the environment in which the user circulates, and/or the features of the skin of the user.

Additionally, the customized data according to the invention includes the desired beauty benefit in the case of a customized cosmetic product (such as anti-ageing action, anti-dark spot action, skin hydration).

Preferably, according to the invention, said device according to the invention comprises a data collection interface as described in documents FR 1203150, FR 1600021, FR 1600023, FR 1600024, WO 2017/118799, WO 2017/118800, WO 2017/118801, WO 2017/118802, WO 2017/118803, which are included herein by way of a reference.

Preferably, according to the invention, said device comprises an interface capable of displaying the information relating to the container and the component that is stored in the identification codes (3), said information comprising the nature of the component and/or the expiry date of the component and/or the source of the container and/or the opening date of the container and/or the remaining amount of the component in the container and/or the number of remaining doses of the component and/or the batch number and/or the serial number and/or the parameters allowing the machine to be configured.

Preferably, according to the invention, said customized data collection interface and said interface capable of displaying information relating to the container and the component are incorporated into the same interface.

This interface can be made up of, for example, a touch screen, a display, a monitor, a keyboard, a display screen, a barcode reader, a light pen, a voice recognition system, a keyboard, a mouse or similar or other peripheral equipment.

Advantageously, according to the invention, the interface can be connected to a computer network, which can be, for example, a computer server, physically connected to the interface or connected via the Internet (also called cloud server), particularly allowing regular updating of the interface and in particular of the database, and/or allowing the manufacturing instructions for a customized product to be remotely transmitted, for example, to a device for manufacturing a customized product.

Preferably, according to the invention, said database is stored in the cloud, or in a server, or directly in the machine.

Preferably, according to the invention, said device comprises a device for processing said data comprising an algorithm for processing said customized data in order to automatically define manufacturing instructions for the customized product in order to determine at least one, preferably all, the component(s) that the customized product must contain and/or to compute the amounts of said component(s) as a function of said customized data.

A data processing device is understood, according to the present invention, to mean a system for automated processing of the data preferably collected by the interface according to the present invention. This data processing device can particularly comprise one or more processing units, memory, software, one or more databases according to the invention. Preferably, the software allows the algorithm of the method according to the present invention to be applied.

The data processing device preferably can comprise a computer. A computer is also understood to mean any electronic device capable of carrying out the automated processing of the data collected by the interface according to the present invention.

Advantageously, according to the invention, the data processing device can be connected to a computer network, to a server, in particular a virtual server (called cloud server) or to the Internet, particularly allowing regular updating of the software, for example, and/or allowing the manufacturing instructions for a customized product to be transmitted remotely.

Advantageously, according to the invention, the data collection interface and the data processing device can be included in the same device (for example, a touch pad, a mobile telephone or a computer, and may or may not be in the form of an application).

Advantageously, the device for manufacturing a customized product according to the present invention can include the same device combining an interface and a data processing device (then called back-end), and/or a second data processing device on a cloud server, with the selection of the data processing device with which the interface must interact from among the two “back-end” or “cloud server” devices being made as a function of the amount of data to be analyzed, in particular as a function of the amount of information entered by the user.

Advantageously, the data processing device comprises an algorithm for processing the data entered into the interface by the user (such as, for example, the selection of the base component), or the selection of the active component as a function of the capsule (4) inserted into the device, by recognizing its identification codes (3), in order to automatically define the suitable components for manufacturing the customized product and compute the amounts of each component as a function of said data. The device preferably comprises at least one computer.

Advantageously, said information or data can be obtained directly by the user, for example, through a questionnaire, or automatically by collecting information from one or more connected objects used by said user, such as a mobile telephone or a watch connected to the Internet, allowing, for example, data to be retrieved that relates to the physical activity carried out by the user during the day, or even the temperature, the humidity level, or the even pollution level of the location of the user based on their geolocation.

Advantageously, the interface comprises buttons arranged on the manufacturing device, preferably 3 backlit buttons, allowing the selected component to be selected. Within the context of a cosmetic product, it can involve, for example, selecting the selected base component, such as a serum base, an oil-in-water emulsion base, or a water-in-oil emulsion.

Preferably, according to the invention, said device according to the invention comprises a data processing device as described in documents FR 1203150, FR 1600021, FR 1600023, FR 1600024, WO 2017/118799, WO 2017/118800, WO 2017/118801, WO 2017/118802, WO 2017/118803, included herein by way of a reference.

Preferably, according to the invention, said device comprises a device for selecting and dosing at least one base component contained in a pot.

Preferably, according to the invention, said device comprises a device for selecting at least one active component in its capsule (4).

Advantageously, the selection device:
rotates about an axis;
is preferably circular or semi-circular;
comprises at least one, two, three, four, five, or at least six slot(s), each able to accommodate a capsule (4);
comprises a safety flap with an orifice allowing the capsule (4) to be inserted into the selection device when the orifice is opposite a slot, then, after it is rotated, preventing the capsule (4) from being inserted into the selection device when the orifice is not opposite a slot.

Preferably, according to the invention, said device according to the invention comprises a selection device as described in documents FR 1203150, FR 1600021, FR 1600023, FR 1600024, WO 2017/118799, WO 2017/118800, WO 2017/118801, WO 2017/118802, WO 2017/118803, which are included herein by way of a reference.

According to a second aspect, the invention relates to the use of the device according to the invention for preparing a customized, preferably cosmetic, product.

A “customized cosmetic product” is understood, according to the invention, to mean a cosmetic product such as a cream, a serum, a gel, an oil, a mask, adapted to the care intentions of the user of the device, or to their needs, for example, with an anti-ageing, anti-dark spot or moisturizing action on the skin.

According to a third aspect, the invention relates to a method for manufacturing a customized product, preferably a cosmetic product, for a user using a device according to the invention, comprising the steps of:
a. collecting the customized data of the user through a customized data collection interface;
b. processing said customized data using an algorithm for automatically defining the components, preferably the active components and/or the base components, of the customized product and computing the amounts of each component as a function of the customized data collected in step a.;
c. displaying the customized formula to the user through an interface and notifying them if one or more container(s) needs to be added to the device, and which one(s);
d. checking the containers using the identification codes (3) that they bear, and the reading means of said device, in order to verify the nature of the component and/or the expiry date of the component and/or the source of the container and/or the opening date of the container and/or the remaining amount of the component in the container and/or the number of remaining doses of the component and/or the batch number and/or the serial number and/or the parameters allowing the machine to be configured;
e. preventing the extraction of the component and notifying the user of the reason via an interface capable of displaying information relating to the container and the component, if the check carried out in step d. is negative;
f. extracting the desired amount of each component in each container and supplying them to a mixing device, if the check carried out in step d. is positive;
g. rewriting, using a means for writing and rewriting the identification code (3) of at least one container, the opening date of the container and/or the remaining amount of the component in the container and/or the number of remaining doses of the component;
h. repeating step d. and steps e. or f. and g., if necessary, for each of the necessary containers, until all the components, preferably cosmetic components, needed to manufacture the customized product have been extracted;
i. mixing said extracted components in a mixing device;
j. supplying the user with the customized, preferably cosmetic, product;
k. optionally cleaning the device.

“Checking” is understood, according to the invention, to mean that the reading means according to the invention will read the information described from the identification codes (3).

A “check carried out is negative” is understood, according to the invention, to mean that the nature of the component is not correct, and/or that the expiry date has passed, and/or that the source of the container is not official, and/or that the remaining amount of the component in the container is not sufficient, and/or that the number of remaining doses of the component is not sufficient, and/or that the batch number and/or the serial number is not recognized.

A “check carried out is positive” is understood, according to the invention, to mean that the nature of the component is correct, and/or that the expiry date has not passed, and/or that the source of the container is official, and/or that the remaining amount of the component in the container is sufficient, and/or that the number of remaining doses of the component is sufficient, and/or that the batch number and/or the serial number is recognized.

“Extract” is understood, according to the invention, to mean extraction from the container, preferably from a pot (2), more preferably by a pump nozzle, and/or from a capsule (4), more preferably by an extraction device, for example, made up of a hollow needle and a means for sucking the component, preferably a cosmetic component, through said hollow needle.

“Supplying the product” is understood, according to the invention, to mean making the final product accessible to the user.

“Rewriting” is understood, according to the invention, to mean that the RFID antenna will update the information on the RFID chip following extraction from each of the containers used to provide the customized product, preferably a cosmetic product, according to the invention.

### FIGURE

FIG. 1 shows a device (1) for manufacturing a customized product, a pot (2) comprising at least two identification codes (3), including an RFID chip, a capsule (4) and RFID antennae (5) allowing rewriting on said RFID chip.

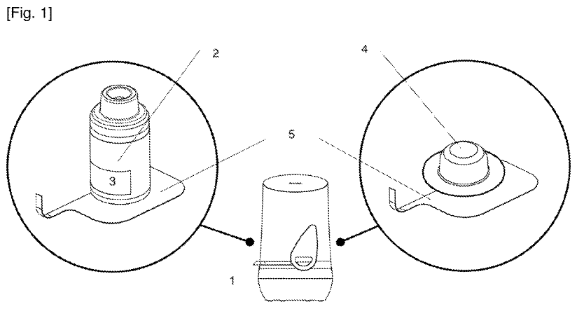

### EXAMPLE

With reference to the drawings, the device according to the invention collects the customized data of the user using its customized data collection interface, and then processes them using an algorithm. The algorithm automatically defines the components needed to supply a customized product, preferably a cosmetic product, as well as the required amounts. The interface then displays the customized formula to the user using the interface and notifies them of the capsules that need to be added to the device. The pots (2), conventionally comprising the base components, preferably cosmetic components, are placed inside the selection device, and the content is extracted therefrom as a function of the customized product using a pump nozzle and is directed towards the mixing device. Following the collection and processing of the customized data of the user, the user adds a capsule (4) to the device, which capsule comprises a component, preferably a cosmetic active ingredient. The identification codes (3) present on the containers are then read by the reading means of the device according to the invention, which allows the information relating to the container and the component to be checked. If the completed check is negative, the device (1) for manufacturing a customized product according to the invention notifies the user as such, and prevents the extraction of the component, and uses the interface to ask the user to change capsule (4). If the completed check is positive, the device (1) for manufacturing a customized product extracts, using a hollow needle and a suction means, the amount from the container that is needed to produce the customized product, and uses the component transfer device to direct it to the mixing device. This step is carried out as many times as there are components to be added to obtain the customized, preferably cosmetic, composition. Once all the components are in the mixing device, and the product is homogeneous, the device supplies the user with the customized, preferably cosmetic, product.

1. A device for manufacturing a customized product, preferably a customized cosmetic product, by mixing at least two components housed in a respective container, at least one of the containers being a capsule, and at least one other container being a pot, preferably comprising a pump nozzle, characterized in that said device comprises a mixing device, said containers are each provided with at least one identification code, the identification code of the capsule and of the pot being identical or different, and in that said device for manufacturing a customized product comprises at least one means for reading said identification code of the capsule, at least one means for reading said identification code of the pot, said reading means possibly being a single reading means in the case where the identification code of the capsule and of the pot are identical, and at least one means for writing and rewriting identification codes of the capsule and/or of the pot.

2. The device according to claim 1, characterized in that said identification codes are selected from color codes, RFID chips, barcodes, QR codes, Datamatrix codes, PDF-417 codes, MaxiCodes, NFC tags, mechanical shapes.

3. The device according to claim 1, characterized in that the means for reading the identification code of the capsule and/or of the pot, and the means for writing and rewriting the identification code of the capsule and/or of the pot are the same device.

4. The device according to claim 1, characterized in that at least one of said identification codes of the capsule and/or of the pot is an RFID chip, and the means for reading, writing and rewriting said RFID chip is an RFID antenna.

5. The device according to claim 1, characterized in that the identification code of the capsule is a QR code, the identification code of the pot is an RFID chip, and the means for reading, writing and rewriting said RFID chip is an RFID antenna.

6. The device according to claim 1, characterized in that said identification codes store information relating to the container and the component, said information comprising the nature of the component and/or the expiry date of the component and/or the source of the container and/or the opening date of the container and/or the remaining amount of the component in the container and/or the number of remaining doses of the component and/or the batch number and/or the serial number and/or parameters allowing the machine to be configured.

7. The device according to claim 6, characterized in that said identification codes store parameters allowing the machine to be configured.

8. The device according to claim 1, characterized in that said device comprises an interface capable of displaying the information relating to the container and the component that is stored in the identification codes, said information comprising the nature of the component and/or the expiry date of the component and/or the source of the container and/or the opening date of the container and/or the remaining amount of the component in the container and/or the number of remaining doses of the component and/or the batch number and/or the serial number and/or the parameters allowing the machine to be configured.

9. The device according to claim 1, characterized in that said device comprises a customized data collection interface capable of interacting with the user to allow the user to indicate their customized data, preferably selected from a predefined database.

10. The device according to claim 9, characterized in that said device comprises a device for processing said customized data comprising an algorithm for processing said customized data, in order to automatically define instructions for manufacturing the customized product in order to determine at least one, preferably all the component(s) that the customized product must contain and/or to compute the amounts of said component(s) as a function of said customized data.

11. Use of the device according to claim 1 to prepare a customized product, preferably a cosmetic product.

12. A method for manufacturing a customized product, preferably a cosmetic product, for a user using a device according to claim 1, comprising the steps of:
a. collecting the customized data of the user through a customized data collection interface;
b. processing said customized data using an algorithm for automatically defining the components, preferably the active components and/or the base components, of the customized product and computing the amounts of each component as a function of the customized data collected in step a.;
c. displaying the customized formula to the user through an interface and notifying them if one or more container(s) needs to be added to the device, and which one(s);
d. checking the containers using the identification codes that they bear, and the reading means of said device, in order to verify the nature of the component and/or the expiry date of the component and/or the source of the container and/or the opening date of the container and/or the remaining amount of the component in the container and/or the number of remaining doses of the component and/or the batch number and/or the serial number and/or the parameters allowing the machine to be configured;
e. preventing the extraction of the component and notifying said user of the reason via an interface capable of displaying information relating to the container and the component, if the check carried out in step d. is negative;
f. extracting the desired amount of each component in each container and delivering them to a mixing device, if the check carried out in step d. is positive;
g. rewriting, using a means for writing and rewriting the identification code of at least one container, the opening date of the container and/or the remaining amount of the component in the container and/or the number of remaining doses of the component;
h. repeating step d. and steps e. or f. and g., if necessary, for each of the necessary containers, until all the components, preferably cosmetic components, needed to manufacture the customized product have been extracted;
i. mixing said extracted components in a mixing device;
j. supplying the user with the customized, preferably cosmetic, product;
k. optionally cleaning the device.
